(19) United States
(12) Patent Application Publication
(10) Pub. No.: US 2019/0198274 A1
(43) Pub. Date: Jun. 27, 2019

(54) Overcurrent Device

(71) Applicant: Kenny Koza, West Bloomfield, MI (US)

(72) Inventor: Kenny Koza, West Bloomfield, MI (US)

(21) Appl. No.: 16/168,568

(22) Filed: Oct. 23, 2018

Related U.S. Application Data
(60) Provisional application No. 62/549,054, filed on Aug. 23, 2017.

(51) Int. Cl. H01H 71/12; H01H 71/04; H01H 71/10

(52) U.S. Cl. CPC H01H 71/12; H01H 2071/042; H01H 71/1045; H01H 71/04

(57) ABSTRACT

Circuit breakers and overcurrent devices are contemplated, such as but not necessarily limited to those that provide visual and electronic data to a database and details of the operating characteristics of the current that flows through to a remote device.

### CROSS-REFERENCE TO RELATED APPLICATIONS

This application claims the benefit of U.S. provisional application No. 62/549,054 filed Aug. 23, 2017, the disclosure of which is incorporated in its entirety by reference herein.

### TECHNICAL FIELD

The present invention relates to circuit breakers and overcurrent devices, such as but not necessarily limited to those that provide visual and electronic data to a database and details of the operating characteristics of the current that flows through to a remote device.

### BACKGROUND

Overcurrent devices, typically referred to as circuit breakers, have been heretofore a method of protecting the conductors that allow current to travel to remote devices. Circuit breakers that are mounted to a panel where the current load is provided have typically been used to protect humans from electrical shock or when the electrical conductors may be overheating to turn the energy on and off. What is needed is an overcurrent device that provides statistics for energy usage, voltage fluctuation, harmonic distortion, voltage leaks and other data required to inform an end user prior to and/or in the event a failure or an overcurrent, optionally in addition to a capability to wireless report such data and/or to wirelessly control the overcurrent device in advance or following overheating or other disruptions through corresponding on/off control.

### BRIEF DESCRIPTION OF THE DRAWINGS

FIG. 1 illustrates an overcurrent device in accordance with one non-limiting aspect of the present invention.

FIG. 2 illustrates functional features of an overcurrent device in accordance with one non-limiting aspect of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

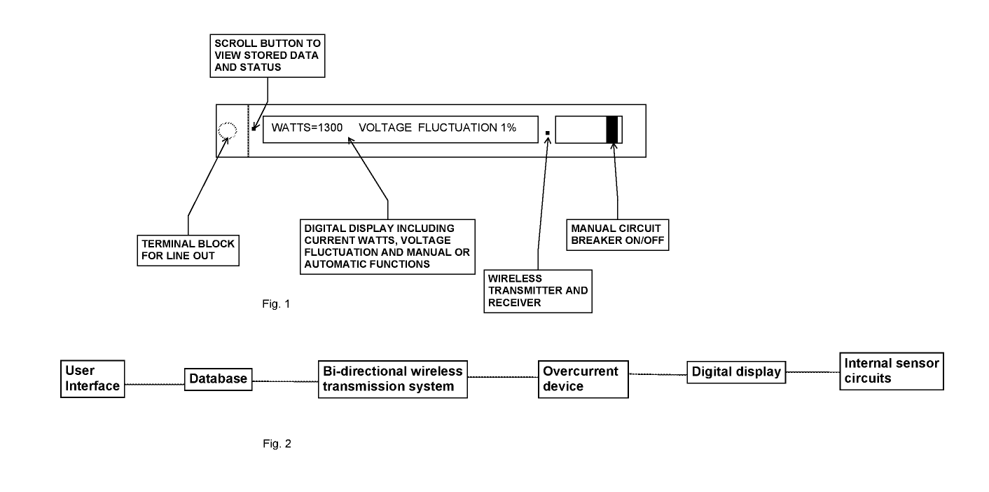

FIG. 1 illustrates an overcurrent device in accordance with one non-limiting aspect of the present invention. The device may be a digitally controllable device having capabilities for wirelessly and/or wiredly communicating over networks, such as but not necessarily limiting to communicating over local networks and the Internet. The device may be configured to turn power on/off and/or to otherwise control the delivery of current therethrough, such as with controllable fuses, breakers, etc. having the capability to be controlled to selective open and close corresponding switches, relays, etc. depending on sensed conditions and control messages sent thereto, optionally in cooperation with manual circuit breaker on/off included on the device (multiple breakers may be included). The device may include a digital readout to show status, power consumption, voltage fluctuation and/or to generate corresponding reports, which may be stored locally and/or transmitted to a monitor/controller located at a remote location, such as to report, status, time on, time off, etc.

One aspect of the present invention contemplated an overcurrent device with a visual screen that indicates the various performance of the device itself, as well as the devices that are connected to it, including but not limited to following capabilities: on or off status; manual or automatic readout; current flowing through the device; wattage used; voltage fluctuations; voltage leaks; harmonic distortion; a mount or other attachment for a panel or panelboard; wireless bi-directional communication that allows data to flow to a database and user interface; a software platform for the user interface that can communicate wirelessly to computers, handheld devices, and third-party building management system; a firmware program that resides in the overcurrent device that stores and directs data to the user interface; a user interfaces with a database, a scheduler and a menu to communicate directly with the device for retrieving data and controlling the times of day, months, years to turn the device on or off; and/or a manual switch on the device that overrides the wireless times for on and off that complies with all industry standards. The hardware of the device may include physical attributes conforming to all of the standards for panel mounted overcurrent devices, a visual screen to show information and/or a pushbutton to scroll through the screen to view multiple status indications.

One aspect of the present invention contemplates a digital circuit breaker with a flat panel breaker design, which may be controlled and/or programmed to eliminate a need for flipping breaker back and forth to be reset and/or eliminate a need for trying to figure out which breaker was triggered or having to pull the lever to reset breaker. The device can take a tap of the flat panel to reset the breaker or log on to a corresponding application and use the virtual breaker panel to reset the breaker. The breaker that defaulted can be set to automatically email, text, etc. and the application can be opened on phone automatically to easily find and know if breaker needs to be reset. The device can know which breaker triggered with use of an led indicator to indicate with red for defaulted breaker and green to show active breakers for visual ease, which may be beneficial in ameliorating confusion as to which one triggered and/or assessing faults without having touch the breakers to see which one was triggered.

When a circuit breaker is over loaded and is set off, the device can show on the application which one needs to be reset to eliminate the need to run down stairs in the dark or try to figure out which breaker went off. The circuit breakers can then be reset from a computer, smart tablet or smart phone, which may be electronically labeled on the application to avoid situations of homes panels being mislabeled or writing having been faded over time making illegible or were never labeled in first place. The electronic identification may be also be edited to identify corresponding locations to further limit the likelihood of mislabeling. When building a panel on the application, customers can choose any size panel to build a custom panel or they can choose panels from a list of loaded panel designs. The digital circuit breaker can track energy consumption and show customer how many watts they are consuming and to identify when nearing a surge, e.g., to know if plugging in a hair dryer will blow the fuse, to allow customers to know why their breaker is being triggered. Threshold measures can be set to notify when currents may be close to triggering the breaker, which could be used to gain general knowledge of where consumers are using the most energy in their home.

From a business/commercial application, a business owner can track energy consumption of each individual office space or retail space and/or hotel room, which may be beneficial in extending life of the rooms and/or appliances by seeing which areas are being mostly used in order to provide maintenance programs. Or if his lease agreement permits, tenants can be charged the appropriate expenses for energy consumption. Outlets when plugged into still costume power, the device can show how much inactive power is being consumed and can also be programmed to turn these devices off at night or when out of town and/or to program on/off, such as outside light or any appliance that needs to be on a timer and/or dawn/dusk sequence may be performed without a separate timer. Panels that have hand writing are very hard to read which breaker is for which location. With the application contemplated herein the phone or other access device can type a perfect and legible label. The device may be a universal breaker designed to enable consumers to buy one and replace only one or change all breakers in an existing home, which could be used to work with a sump pump, fish tank, refrigerator, etc. so that users have ease of mind that you'll know if something critical has lost power or triggered.

The present invention may be used to turn off breaker from inside a room to eliminate a need to run back and forth to turn off a breaker when troubleshooting or installing circuits. Automatic load shedding can be implemented with a generator if too many breakers are put on it and the generator can't handle it, e.g., when an air conditioner unit is having a problem running, the breaker can sense the generator is on and remove the air condition, optionally with settings so that the automatic shedding can be turned off. The device may send monthly energy reports and the like and/or compare the report to what an energy company is reporting to assess mischarges and/or know how to cut back on energy consumption with an assessment of connected devices consuming the most power.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An overcurrent device comprising:
one or more breakers;
a wireless interface for exchanging wireless signaling with an application;
a controller for controlling the breakers, generating reports and wirelessly interfacing with the application.
